(19) United States
(12) Patent Application Publication
(10) Pub. No.: US 2023/0237547 A1
(43) Pub. Date: Jul. 27, 2023

(54) COLLECTING METERING DATA OF ON-PREMISES COMPUTING RESOURCES WITHOUT NETWORK CONNECTION

(71) Applicant: Lenovo Global Technology (United States) Inc., Morrisville, NC (US)

(72) Inventors: Prashant Bhosale, Rahatani Pune (IN); Eric R. Kern, Chapel Hill, NC (US); Robert Furda, Bratislava (SK); Jeffery J. Van Heuklon, Rochester, MN (US)

(21) Appl. No.: 17/582,618

(22) Filed: Jan. 24, 2022

(51) Int. Cl. G06Q 30/04; G06Q 50/06; H04L 9/40

(52) U.S. Cl. CPC G06Q 30/04; G06Q 50/06; H04L 63/0428

(57) ABSTRACT

A method for collecting metering data of on-premises computing resources without a network connection includes generating a unique signature at an off-premises server with a billing system configured to process metering data for a remote server at an on-premises site and to generate a bill based on the metering data. The off-premises server is not connected via a data network to an on-premises site with the remote server. The method includes inputting the unique signature at the on-premises site, encrypting the metering data of the remote server using the unique signature, downloading the encrypted metering data to a portable storage device at the on-premises site, and decrypting, by the off-premises server, the encrypted metering data using the unique signature. The portable storage device is disconnected from a server at the on-premises site when connected to the off-premises server. The method includes uploading the metering data using the off-premises server.

### FIELD

The subject matter disclosed herein relates to billing of leased computing resources and more particularly relates to collecting metering data of on-premises computing resources without a network connection.

### BACKGROUND

Typically cloud models have their own way that customers can determine resource allocation and usage. Billing is a crucial part in the consumption cloud model that periodically collects metering data from all allocated resources of the cloud infrastructure. Infrastructure-as-a-Service in cloud computing model allows customers to transform the cost in an operational expenditure. The private cloud computing model typically has infrastructure installed in the customer data center that is managed by a cloud service provider. In such cases metering data will be collected from on-premises deployment by various methods and sent over to an off-premises location of the cloud service provider to calculate the billings. Often, an online connection from the on-premises data center to the off-premises is used to transmit metering data. In the absence of such a connectivity, the metering data cannot be online uploaded. A consequence is that only minimally defined profit can be achieved if the metering data is missing and, in addition, lack of metering data can have negative impact on potential planned additional earnings from the business.

### BRIEF SUMMARY

A method for collecting metering data of on-premises computing resources without a network connection is disclosed. The method includes generating a unique signature at an off-premises server with a billing system configured to process metering data for a remote server at an on-premises site and to generate a bill based on the metering data. The off-premises server is not connected via a data network to an on-premises site with the remote server. The method includes inputting the unique signature at a server located at the on-premises site. The server includes access to metering data of the remote server. The method includes encrypting the metering data of the remote server using the unique signature, downloading the encrypted metering data to a portable storage device accessible at the on-premises site, and decrypting, by the off-premises server, the encrypted metering data using the unique signature. The portable storage device is disconnected from the server at the on-premises site when connected to the off-premises server. The method includes uploading the metering data using the off-premises server.

An apparatus for collecting metering data of on-premises computing resources without a network connection includes a processor and non-transitory computer readable storage media storing code. The code is executable by the processor to perform operations that include generating a unique signature at an off-premises server with a billing system configured to process metering data for an remote server at an on-premises site and to generate a bill based on the metering data. The off-premises server is not connected via a data network to an on-premises site comprising the remote server. The operations include decrypting, by the off-premises server, encrypted metering data using the unique signature. The encrypted metering data is metering data of the remote server, is encrypted using the unique signature and downloaded on to the portable storage device from a server at the on-premises site. The portable storage device is disconnected from the server at the on-premises site when connected to the off-premises server. The operations include uploading the metering data using the off-premises server.

A program product for collecting metering data of on-premises computing resources without a network connection includes a non-volatile computer readable storage medium storing code. The code is configured to be executable by a processor to perform operations that include generating a unique signature at an off-premises server with a billing system configured to process metering data for an remote server at an on-premises site and to generate a bill based on the metering data. The off-premises server is not connected via a data network to an on-premises site with the remote server. The code is configured to be executable by a processor to perform operations that include decrypting, by the off-premises server, encrypted metering data using the unique signature. The encrypted metering data is metering data of the remote server, is encrypted using the unique signature and downloaded on to a portable storage device from a server at the on-premises site. The code is configured to be executable by the processor to perform operations that include uploading the metering data using the off-premises server. The portable storage device is disconnected from the server at the on-premises site connected to the off-premises server.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a system for collecting metering data of on-premises computing resources without a network connection, according to various embodiments;

FIG. 2 is a schematic block diagram illustrating an apparatus for metering data sampling in a controller of a remote server, according to various embodiments;

FIG. 3 is a schematic block diagram illustrating an apparatus for gathering, encrypting and downloading metering data onto a portable storage device, according to various embodiments;

FIG. 4 is a schematic block diagram illustrating an apparatus for decrypting and uploading metering data at an off-premises site, according to various embodiments;

FIG. 5 is a schematic flow chart diagram illustrating a method for collecting metering data of on-premises computing resources without a network connection, according to various embodiments;

FIG. 6 is a schematic flow chart diagram illustrating another method for collecting metering data of on-premises computing resources without a network connection, according to various embodiments; and

FIG. 7 is a graph depicting correlation between central processing unit (“CPU”) utilization and system power consumption.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of various embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiments. For instance, an arrow may indicate a waiting or monitoring period of unspecified duration between enumerated steps of the depicted embodiments. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

A method for collecting metering data of on-premises computing resources without a network connection is disclosed. The method includes generating a unique signature at an off-premises server with a billing system configured to process metering data for a remote server at an on-premises site and to generate a bill based on the metering data. The off-premises server is not connected via a data network to an on-premises site with the remote server. The method includes inputting the unique signature at a server located at the on-premises site. The server includes access to metering data of the remote server. The method includes encrypting the metering data of the remote server using the unique signature, downloading the encrypted metering data to a portable storage device accessible at the on-premises site, and decrypting, by the off-premises server, the encrypted metering data using the unique signature. The portable storage device is disconnected from the server at the on-premises site when connected to the off-premises server. The method includes uploading the metering data using the off-premises server.

In some embodiments, the method includes generating billing information based on the uploaded metering data, and making the billing information available to a customer. The customer uses the remote server. In other embodiments, the method includes generating an alert in response to determining that a signature other than the unique signature was used to encrypt the metering data. In other embodiments, the method includes, in response to downloading the encrypted metering data, transporting the portable storage device with the encrypted metering data to a location accessible to the off-premises server. In other embodiments, the unique signature is valid for a single instance of decrypting the encrypted metering data.

In some embodiments, the on-premises site includes a data export tool configured to store metering data in a protected state. The stored metering data at the on-premises site is inaccessible to users without credentials to access the stored metering data, and the unique signature and/or a password provides to access the stored metering data. In other embodiments, the off-premises server stores account information regarding the remote server and the unique signature is correlated to the account information, and the method includes, prior to decrypting the encrypted metering data, retrieving the unique signature by entering account information related to the encrypted metering data.

In some embodiments, the on-premises site includes on-premises computer readable storage media reserved for storing metering data. The on-premises computer readable storage media is sized to store metering data for more than one billing period. In other embodiments, the metering data includes power consumption data of the remote server, utilization of the remote server, and/or operational data of the remote server. In other embodiments, the metering data of the remote server is gathered using metering capabilities connected to the remote server.

An apparatus for collecting metering data of on-premises computing resources without a network connection includes a processor and non-transitory computer readable storage media storing code. The code is executable by the processor to perform operations that include generating a unique signature at an off-premises server with a billing system configured to process metering data for an remote server at an on-premises site and to generate a bill based on the metering data. The off-premises server is not connected via a data network to an on-premises site comprising the remote server. The operations include decrypting, by the off-premises server, encrypted metering data using the unique signature. The encrypted metering data is metering data of the remote server, is encrypted using the unique signature and downloaded on to the portable storage device from a server at the on-premises site. The portable storage device is disconnected from the server at the on-premises site when connected to the off-premises server. The operations include uploading the metering data using the off-premises server.

In some embodiments, the operations include generating billing information based on the uploaded metering data and making the billing information available to a customer using the remote server. In other embodiments, the apparatus includes a security module configured to generate an alert in response to determining that a signature other than the unique signature was used to encrypt the metering data. In other embodiments, in response to downloading the encrypted metering data, a user transports the portable storage device with the encrypted metering data to a location accessible to the off-premises server. In other embodiments, the on-premises site has a data export tool configured to store metering data in a protected state. The stored metering data at the on-premises site is inaccessible to users without credentials to access the stored metering data, and the unique signature and/or a password provides to access the stored metering data.

In some embodiments, the off-premises server stores account information regarding the remote server and the unique signature is correlated to the account information, and the decryption module, prior to decrypting the encrypted metering data, retrieves the unique signature by entering account information related to the encrypted metering data. In other embodiments, the on-premises site includes on-premises computer readable storage media reserved for storing metering data. The on-premises computer readable storage media is sized to store metering data for more than one billing period. In other embodiments, the metering data includes power consumption data of the remote server, utilization of the remote server, and/or operational data of the remote server. In other embodiments, the metering data of the remote server is gathered using metering capabilities connected to the remote server.

A program product for collecting metering data of on-premises computing resources without a network connection includes a non-volatile computer readable storage medium storing code. The code is configured to be executable by a processor to perform operations that include decrypting, by the off-premises server, encrypted metering data using the unique signature. The encrypted metering data is metering data of the remote server, is encrypted using the unique signature and downloaded on to a portable storage device from a server at the on-premises site. The code is configured to be executable by the processor to perform operations that include uploading the metering data using the off-premises server. The portable storage device is disconnected from the server at the on-premises site when connected to the off-premises server.

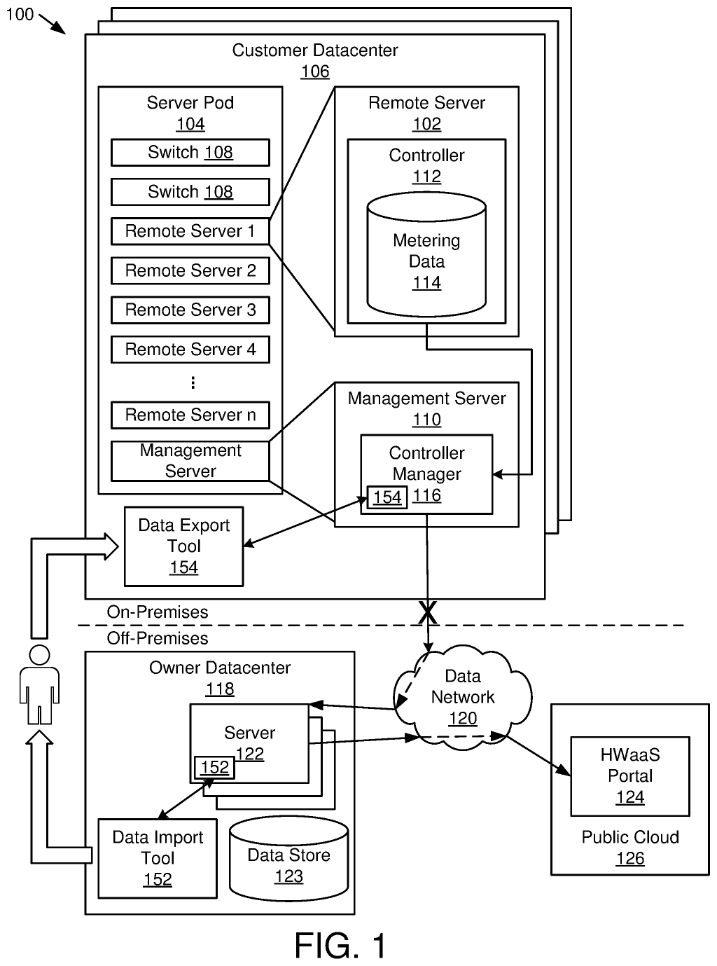

FIG. 1 is a schematic block diagram illustrating a system 100 for collecting metering data of on-premises computing resources without a network connection, according to various embodiments. Includes one or more remote servers 102a-n (generically or collectively “102”) in a server pod 104 at a customer datacenter 106 or other customer facility (“on-premises site”). The remote servers 102 are remote from an owner's facility (“off-premises site”) where the owner (lessor), in some embodiments, owns the remote servers 102 and leases the remote servers 102 to a customer (lessee). In some embodiments, the owner maintains the remote servers 102 and bills the customer based on usage of the remote servers 102. The server pod 104, in some embodiments, includes switches 108 and may be mounted in one or more racks. The server pod 104 may also include power supplies (not shown), data storage devices (not shown), and other equipment known to those of skill in the art.

In some embodiments, the server pod 104 includes a management server 110 which controls various aspects of the remote servers 102. In some examples, the management server 110 is a baseboard management controller (“BMC”) or a controller that manages BMCs in the remote servers 102. The management server 110, in some embodiments, monitors internal physical variables in the remote servers 102, such as temperature, humidity, power supply voltage, fan speeds, communication parameters, operating system (“OS”) functions, and the like. For example, the management server 110 may establish a virtual machine (“VM”), may allocate server resources to the VM, may initiate an OS instance in the VM, may route or assign jobs to the VM, etc. One of skill in the art will recognize other ways that a management server 110 functions with respect to the remote servers 102.

In some embodiments, the remote servers 102 each include a controller 112 that measures and stores power consumption data, utilization data, operational data and other metering data 114 of the remote server 102. In some examples, the controller 112 is a BMC. In other embodiments, the controller 112 is an Xclarity® controller by Lenovo® or a controller with similar functionality. The controller 112, in some embodiments, monitors overall power consumption of the remote server 102 in which it resides, such as server input power. In other embodiments, the controller 112 monitors power consumption of various components of the remote server 102. For example, the controller 112 may measure CPU power, a memory power, graphical processor unit (“GPU”), fan power, and the like and stores the metering data 114. In other embodiments, the controller 112 monitors other data that is part of the metering data 114.

In some embodiments, the management server 110 includes a controller manager 116 that collects metering data 114 from each remote server 102. At some customer sites, the controller manager 116 transmits the metering data 114 to a server 122 of an owner datacenter 118 (i.e. datacenter of the lessor) over a data network 120 and the metering data 114 is stored in a data storage device 123 at the owner data center 118. However, some customers prefer to not have a live data link from the management server 110 to a device outside the on-premises site for various reasons, such as for security. In such instances, the controller manager 116 or management server 110 includes a data export tool 154 to facilitate transferring metering data 114 to a portable storage device.

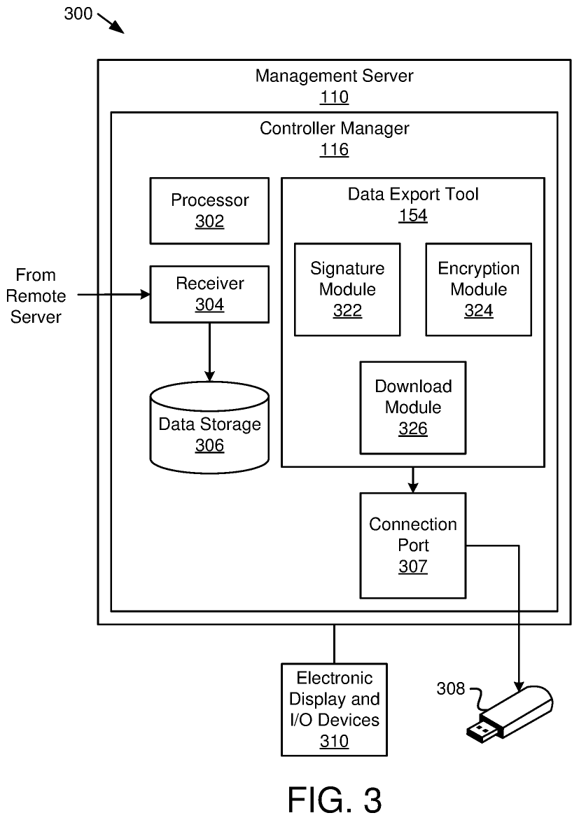

In some examples, the controller manager 116 is an Xclarity® Administrator that manages several remote servers 102 and associated controllers 112. In some embodiments, the controller manager 116 stores transmits metering data 114 on computer readable storage media for later retrieval. For example, the controller manager 116 may store metering data 114 for at least one billing period. In some embodiments, the controller manager 116 stores at least a month of metering data 114, which may correlate to a billing period. In other embodiments, the controller manager 116 stores metering data 114 for more than a billing period. For example, the controller manager 116 may store metering data 114 for at least two billing periods, which provides a buffer if the metering data 114 is not downloaded for a billing period. The data export tool 154 is described further with regard to the apparatus 300 of FIG. 3.

In some embodiments, the data network 120 is local area network (“LAN”), a wide area network (“WAN”), a fiber network, a wireless network, a cellular network, the Internet, etc. and may also include a combination of network types. The data network 120 includes data cables, servers, switches, routers, and/or other networking equipment.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™

Alternatively, the wireless connection may employ a ZigBee® connection based on the IEEE 802 standard. In some embodiments, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

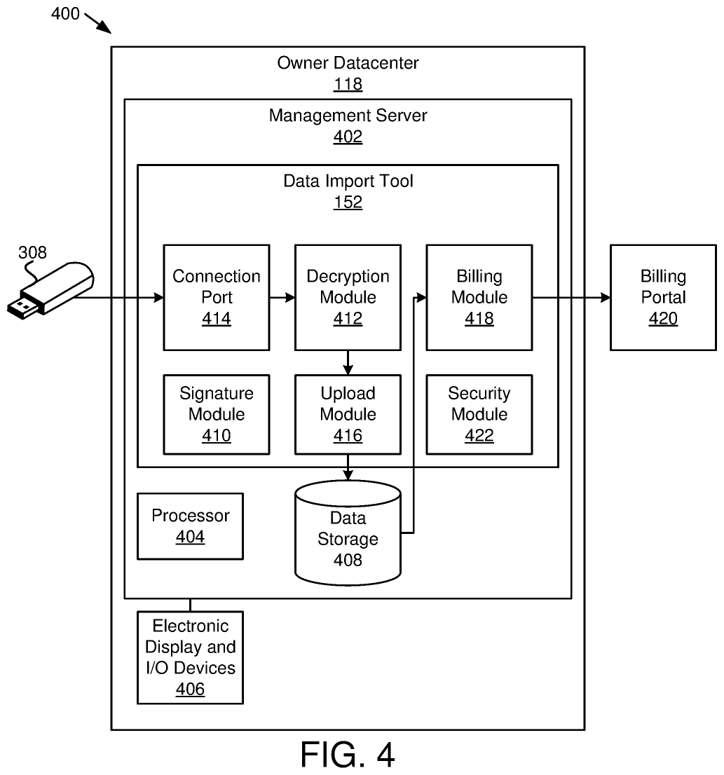

The owner datacenter 118 or other on-premises server 122 includes a data import tool 152 configured to generate a unique signature correlated to a contract for leasing or renting remote servers 102 or other equipment at the customer datacenter 106. The data import tool 152 also connects to a portable storage device with encrypted metering data 114, retrieves the appropriate unique signature to decrypt the encrypted metering data 114 and upload the metering data 114 to the data storage device 123 accessible to the server 122 for using in creating billing information related to the metering data 114. The data import tool 152 is described further with regard to the apparatus 400 of FIG. 4.

In some embodiments, the server 122 of the owner datacenter 118 processes metering data 114 to create pricing information, which is sent to a hardware-as-a-service (“HwaaS”) portal 124 in a public cloud 126 for creation of a bill to be made available to the customer. In other embodiments, bills are created and made available to the customer from within the owner datacenter 118. In some embodiments, the HwaaS portal 124 is a Lenovo TruScale™ portal, which is part of a pay-for-what-you-use datacenter technology that charges the customer based on actual use of the remote servers 102. In some embodiments, actual use is based on CPU utilization. For example, a lightly loaded remote server 102 may be charged less than a heavily loaded remote server 102.

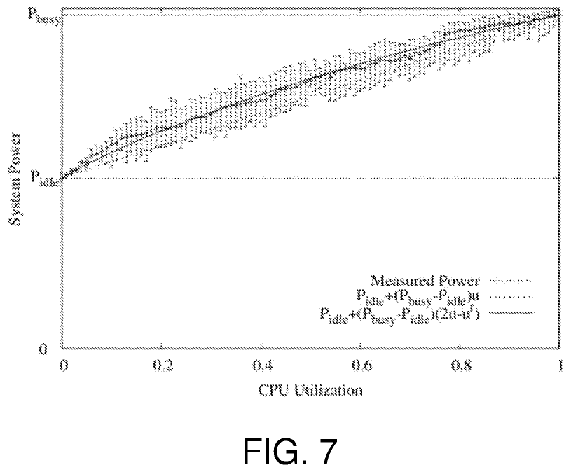

While traditional billing may charge based on monitoring CPU utilization, power consumption data of the metering data 114 may be used for customer billing. FIG. 7 is a graph depicting correlation between CPU utilization and system power consumption. The horizonal axis is CPU utilization and the vertical axis is system power. As can be seen in the graph, system power correlates very closely to CPU utilization between a no load condition (CPU utilization of 0) where a minimal amount of power is used and depicted as Pidle, and a fully loaded condition (CPU utilization is 1) where a maximum amount of power is used and depicted as P_{busy}. Basing customer billing of usage of a remote server 102 on power consumption of the remote server 102 provides a simple, straight-forward method of indirectly measuring CPU utilization that correlates nicely to system power, which is readily available as a measured value. In other embodiments, the metering data 114 includes other data, such as CPU utilization, operating parameters, and the like.

Collecting metering data 114 of a remote server 102 also provides information that can be used along with health alerts to predict server failures, which allows the owner to be prepared for an upcoming failure in a remote server 102. In some embodiments, the controller 112 and/or controller manager 116 store health alerts, which are included in the metering data 114 to be downloaded to a portable storage device for later uploading to the owner datacenter 118 for analysis and action. The controller 112 and/or controller manager 116, in some embodiments, generate alerts that are sent to the customer on-premises. A health alert includes minor issues, such as an unexpected temperature rise, a memory fault, a reset of a component, an error message of a component, or other abnormal condition, and also includes failures, such as a failure of a CPU, a failure of a fan, a memory failure, etc. Typically, the controller 112 and/or controller manager 116 store/send health alerts on a different schedule than metering data 114.

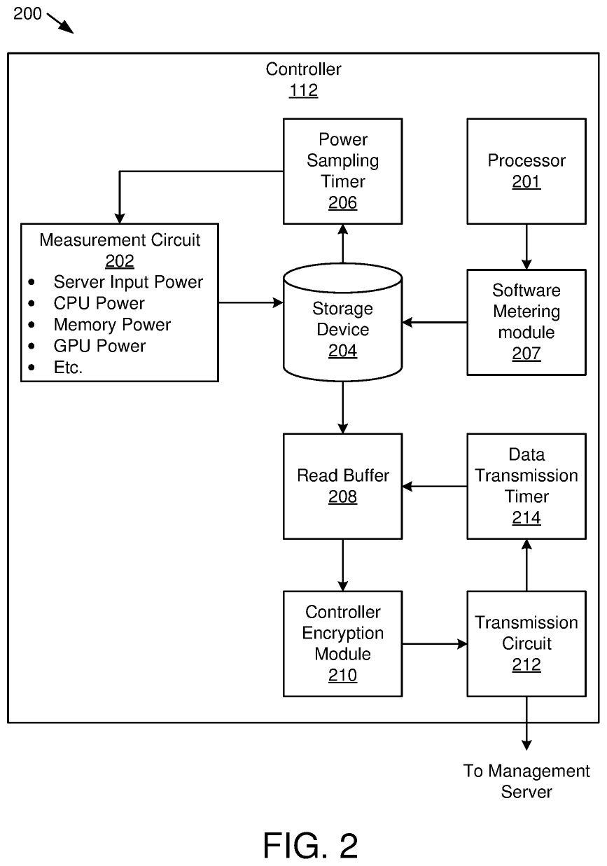

FIG. 2 is a schematic block diagram illustrating an apparatus 200 for metering data sampling in a controller 112 of a remote server 102, according to various embodiments. The apparatus 200 is an expanded view of the controller 112 of the remote server 102 in the system 100 of FIG. 1. A processor 201 of the controller 112 controls implementation of measuring power of the remote server 102 and other functions depicted in FIG. 2. The apparatus 200 includes a measurement circuit 202 that measures power in the remote server 102 to produce power consumption data. In some embodiments, the measurement circuit 202 measures input power to the remote server 102. In other embodiments, the measurement circuit 202 measures power for components in the remote server 102. The components may be CPU power, memory power, GPU power, fan power, core power, storage device power, and the like. Measuring power for components, coupled with health alerts regarding components in the remote server 102, provides a unique correlation that is useful in predicting component failure and failure of the overall remote server 102.

In some embodiments, the measurement circuit 202 reads power from measurements that are available from components of the remote server 102. In other embodiments, the measurement circuit 202 includes hardware for power measurements. The power measurements typically include measuring current and voltage. In some embodiments, where voltage is known, the measurement circuit 202 only measures current of a component.

In some embodiments, the measurement circuit 202 includes appropriate equations for power measurement. For example, the measurement circuit 202 may measure direct current (“DC”) voltage and current and may multiply voltage and current to get a power measurement. In other embodiments, the measurement circuit 202 measures alternating current (“AC”) voltage and current and accounts for power factor. In some embodiments, the measurement circuit 202 uses hardware circuits to determine power. In other embodiments, the measurement circuit 202 receives measurements and uses a processor and executable code to determine power from the measurements. One of skill in the art will recognize other ways for the measurement circuit 202 to measure power of various components and input power of the remote server 102.

The apparatus 200 includes a storage device 204 that stores power consumption data as part of or all of the metering data 114. In some embodiments, the storage device 204 includes voltage storage, such as a register, random access memory (“RAM”), and the like. In other embodiments, the storage device 204 is a non-volatile storage device such as flash memory, etc., which may be termed a computer readable storage medium. In some embodiments, the storage device 204 inputs new power consumption data and removes the oldest power consumption data. In one example, the storage device 204 is a first-in-first-out (“FIFO”) buffer where when new power consumption data is input, the oldest power consumption data is forced out.

In some embodiments, measurement circuit 202 measures power at a particular sampling rate and the storage device 204 stores a particular amount of power measurement samples. For example, the sampling rate may be 30 seconds, 1 minute, 2 minutes, etc. and the storage device 204 holds several minutes or several hours of power measurement samples. The sampling rate may be very short, for example on a microsecond level, or may be longer, such as on the minute, tens of minutes, or hour scale, as appropriate for the remote servers 102. In some embodiments, power consumption data in the storage device 204 is read at a particular data transmission rate and the frequency of power measurement samples is greater than the data transmission rate. In some embodiments, the storage device 204 stores enough power measurement samples to cover two transmissions of power consumption data. For example, if the data transmission rate is every 6 hours, the storage device 204 holds at least 12 hours of power consumption data, which provides a safety mechanism so that if a particular transmission of power consumption data fails, a next transmission of power consumption data will cover power consumption data missing from the previous transmission of power consumption data.

In some embodiments, the apparatus 200 includes a power sampling timer 206 that sets a measurement rate for the measurement circuit 202. For example, the power sampling timer 206 may be set at 30 seconds after every measurement by the measurement circuit 202 so that at when the power sampling timer 206 counts down to zero or up to the power sampling rate, the power sampling timer 206 sends a signal to the measurement circuit 202 to take another sample of power consumption data. In some embodiments, the power sampling timer 206 is a hardware timer. In other embodiments, the power sampling timer 206 is a software time executed by a processor.

In some embodiments, the controller 112 includes a software metering module 207 configured to meter certain parameters available in the remote servers 102, operating systems, etc. For example, the software metering module 207 may track CPU utilization. In other embodiments, the software metering module 207 tracks graphical processor unit (“GPU”) activity. In other embodiments, the software metering module 207 tracks VM operations. The software metering module 207 tracks any parameter useful in billing the customer of the on-premises site and stores data from tracking the parameters in the storage device 204 as part or all of the metering data 114. In some embodiments, the controller 112 does not track power consumption data and solely relies on metering by the software metering module 207. In other embodiments, the controller 112 stores power consumption data as well as other data from the software metering module 207 as metering data 114. One of skill in the art will recognize various ways to meter equipment leased, rented, etc. by the customer for billing purposes.

The apparatus 200, in some embodiments, includes a read buffer 208 that holds power consumption data, operational parameters, utilization parameters, etc. of the metering data 114 from the storage device 204 prior to transmission of the metering data 114 to the management server 110. For example, the controller 112 may transfer data from the storage device 204 o the read buffer 208 to create a snapshot of power consumption data and/or other data to be transmitted. In some embodiments, all of the metering data 114 is read from the storage device 204 and stored in the read buffer 208. In other embodiments, the controller 112 transfers enough data from the storage device 204 to the read buffer 208 to just cover a period from a previous transmission of metering data 114. In the embodiments, if a transmission fails, the controller 112 may attempt to transmit metering data 114 again so that no data is lost. In embodiments where the controller 112 transmits enough metering data 114 to cover twice the data transmission rate, an alert may be sent to correct transmission issues before a next data transmission. One of skill in the art will recognize other ways to not lose data due to a data transmission failure.

The apparatus 200 optionally includes a controller encryption module 210 that encrypts data from the read buffer 208 prior to transmission. In some embodiments, the controller encryption module 210 includes one or more hardware circuits for encrypting data. In other embodiments, the controller encryption module 210 includes executable code and encryption of data from the read buffer 208 is accomplished by the processor 201 executing the code. In other embodiments, the controller encryption module 210 includes instructions in a programmable hardware device. One of skill in the art will recognize other ways to implement the controller encryption module 210. The controller encryption module 210 encrypts metering data 114 prior to transmission for security purposes and encryption methods are known in the art.

The apparatus 200 includes a transmission circuit 212 that transmits the metering data 114 after encryption to the controller manager 116 of the management server 110. The transmission circuit 212 may include transmission over a data bus and includes hardware circuits necessary for safe transmission of the metering data 114 to the controller manager 116. In some embodiments, where the controller manager 116 is connected securely to the controller 112, the metering data 114 may not be encrypted before sending to the controller manager 116 and encryption may be done by the controller manager 116. In the depicted embodiments, the metering data 114 is encrypted by a controller encryption module 210 in the controller 112 so that the metering data 114 does not need to be encrypted by the controller manager 116. In some examples, the transmission circuit 212 is connected to the controller manager 116 through a switch 108. In other embodiments, where transmission of the metering data 114 is over a network, the transmission circuit 212 is a network interface card (“NIC”) or similar circuit.

The apparatus 200, in some embodiments, includes a data transmission timer 214 that sets a data transmission rate of the metering data 114 to the controller manager 116. For example, the data transmission rate may be every six hours, every eight hours, every twelve hours, once a day, etc. and the data transmission timer 214 stores and controls the data transmission rate. In some embodiments, a user interacts with the controller 112 and to set a data transmission rate in the data transmission timer 214. The data transmission timer 214 may be a hardware timer or a software timer or may include both hardware and software elements. For example, a software timer may interact with hardware to send a signal to the read buffer 208. Note that the devices 202-214 in FIG. 2 are conceptual and may be implemented in other ways to accomplish measuring power consumption of various components and/or input power to a remote server 102 at a particular sampling rate, storing a particular amount of the most recent samples, and then transmitting metering data to the controller manager 116 at a rate less than the power sampling rate.

FIG. 3 is a schematic block diagram illustrating an apparatus 300 for gathering, encrypting and downloading metering data onto a portable storage device, according to various embodiments. The apparatus 300 includes a processor 302, a receiver 304 that receives metering data 114 from remote servers 102, a data storage device 306, an electronic display and input/output (“IO”) devices 310, a data export tool 154 with a signature input module 322, an encryption module 324, and a download module 326, a connection port 307, and a portable storage device 312, which are described below. The devices and modules 302-310, 322-326 are conceptual and one of skill in the art will recognize how to implement the functionality of the devices and modules 302-310, 322-326 in various forms. In some embodiments, at least a portion of the devices and modules 302-310, 322-326 are implements using hardware circuits and/or a programmable hardware device. In other embodiments, the modules 322-326 are implemented with code stored on a computer readable storage device.

The processor 302, receiver 304, data storage device 306, and/or the connection port 307 are depicted in the controller manager 116 for convenience, but in some embodiments, are in the management server 110. The data storage device 306, in some embodiments, is located external to the controller manager 116/management server 110. In one example, the receiver 304 is connected to each remote server 102 in a server pod 104 or other group of remote servers 102, for example, through a switch 108. In other embodiments, the receiver 304 is connected to the remote servers 102 over a computer network and the receiver 304 is a NIC.

The apparatus 300, in some embodiments, stores metering data 114 from each remote server 102 and/or other computing equipment owned by the owner and leased or rented by the customer in a data storage device 306. In some embodiments described below, the metering data 114 is described as being from a remote server 102. As used herein, the metering data 114 from a remote server 102 also includes metering data 114 from a plurality of remote servers 102 and/or other leased/rented computing devices. The data storage device 306 is typically non-volatile storage, and may be solid-state storage, a hard disk drive, etc. and may be called a computer readable storage medium. In some embodiments, the data storage device 306 at the controller manager 116 is multiple data storage devices. For example, the data storage device 306 may be a virtual data storage device mapped to multiple physical data storage devices. In the depicted embodiments, the data storage device 306 stores encrypted metering data 114.

The apparatus 300 includes a connection port 307 for connection to a portable storage device 308. In some embodiments, the connection port 307 is a universal serial bus (“USB”) connector and may be a standard USB connector, a mini USB connector, a micro USB connector, a USB-C connector, or other type of USB connector. In other embodiments, the connection port 307 is a data network connector, such as an RJ45 jack, an optical fiber connector, etc. In other embodiments, the connection port 307 is a memory card connector, such as a secure digital (“SD”) connector, a mini SD connector, a micro SD connector, a compact flash (“CF”) connector, or the like. In other embodiments, the connection port 307 is a solid state storage (“SSD”) connector, such as an M.2 SSD connector. The embodiments described herein contemplate any type of connection port 307 and associated portable storage device 308. One of skill in the art will recognize other types of connection ports 306 for other types of portable storage devices 308.

The apparatus 300 includes one or more electronic displays and/or I0 devices 310, such as a keyboard, a mouse, a trackpad, etc. for accessing, encrypting, downloading, etc. the metering data 114. In some embodiments, the one or more electronic displays and/or IO devices 310 enable a user to access the data export tool 154 via a metering user interface. In some examples, the data export tool 154 displays a mechanism to access the metering data 114, to enter a unique signature, to encrypt the metering data 114, to download the encrypted metering data 114 to the portable storage device 308, and other management functions associated with exporting the metering data 114.

In some embodiments, the data export tool 154 at the on-premises site is configured to store metering data 114 in a protected state where the stored metering data 114 is inaccessible to users without credentials to access the stored metering data 114. In some embodiments, the unique signature and/or a password provides to access the stored metering data 114.

The apparatus 300 includes a signature input module 322 configured to input the unique signature at the metering user interface located at the on-premises site. The metering user interface includes access to metering data 114 of the remote server(s) 102. In some embodiments, the unique signature is input via a keyboard, mouse, or other IO device. In other embodiments, the unique signature is stored on the portable storage device 308 and the signature input module 322 accesses the unique signature on the portable storage device 308. In some examples, a user initiates the signature input module 322 accessing the unique signature on the portable storage device 308. In some embodiments, the data export tool 154 facilitates inputting or accessing the unique signature.

The apparatus 300 includes an encryption module 324 configured to encrypt the metering data 114 of the remote server(s) 102 using the unique signature. In some embodiments, the encryption module 324 adds a layer of encryption on top of encryption by the controller encryption module 210. For example, the controller encryption module 210 may encrypt the metering data 114 with an on-premises signature while the encryption module 324 in the data export tool 154 encrypts the metering data 114 with the unique signature. In other embodiments, the receiver 304 or other device in the controller manager 116 and/or the management server 110 decrypts the metering data 114 and the encryption module 324 in the data export tool 154 re-encrypts the metering data 114 using the unique signature.

In other embodiments, metering data 114 is not encrypted before transmission to the management server 110 and the encryption module 324 encrypts the metering data 114 using the unique signature. In other embodiments, the encryption module 324 and/or the controller encryption module 210 use the unique signature to encrypt the metering data 114. For example, the unique signature may be available to the controller 112 and/or management server 110 for encryption of metering data 114 on a long-term basis. One of skill in the art will recognize other ways for the encryption module 324 to encrypt the metering data 114 using the unique signature.

The apparatus 300 includes a download module 326 configured to download the encrypted metering data 114 to a portable storage device 38 accessible to the metering user interface at the on-premises site. In some embodiments, the encryption module 324 and the download module 326 work together to encrypt and download the metering data 114. In some embodiments, the data export tool 154 includes a function to select the metering data 114 for download, to select the portable storage device 308 as a destination for the metering data 114, to initiate downloading the metering data 114, and the like.

FIG. 4 is a schematic block diagram illustrating an apparatus 400 for decrypting and uploading metering data at an off-premises site, according to various embodiments. The apparatus 400 includes a management server 402 in an owner datacenter 118. The management server 402, in some embodiments, is substantially similar to the server 122 of the system 100 of FIG. 1. The management server 402 includes a processor 404, connection to an electronic display and/or IO devices 406, a data storage device 408, and a data import tool 152. The data import tool 152 includes a signature module, 410, a decryption module 412, a connection port 414 for connection to the portable storage device 308, a billing module 418, and/or a security module 422, and the billing module is connected to a billing portal 420, all of which are described below. The devices, modules, tool, etc. 152, 402-422 are conceptual and one of skill in the art will recognize how to implement the functionality of the devices, modules and tool 152, 402-422 in various forms. In some embodiments, at least a portion of the devices, modules and tool 152, 402-422 are implements using hardware circuits and/or a programmable hardware device. In other embodiments, the modules 410, 412, 416, 418, 422 are implemented with code stored on a computer readable storage device.

The management server 402, in some embodiments, is located in an owner datacenter 118 wherein the owner is the owner of the remote servers 102 and/or other computing devices and the customer leases or rents the remote servers 102 and/or the other computing devices. In other embodiments, the management server 402 is located off-premises from the customer datacenter 106 and is controlled by the owner. In some embodiments, the management server 402 is similar to the server 122 of the system 100 of FIG. 1.

The management server 402 includes a processor 404 that executes code, such as various applications. In some embodiments, the code includes a management application capable of accessing the management server 110, the controller 112, the remote servers 102, etc. In some examples, the management server 110 in the customer datacenter 106 is a BMC or similar management server and the controller manager 116 is an Xclarity Administrator and the management server 402 in the owner datacenter 118 or elsewhere accesses the Xclarity Administrator, the BMC, etc. The management server 402 is connected to an electronic display and/or I0 devices 406 that facilitate interaction with the management server 402 by a user.

The management server 402, in some embodiments, includes a data import tool 152 with a signature module 410, a decryption module 412, a billing module 418, and/or a security module 422. In other embodiments, the signature module 410, the decryption module 412, the billing module 418, and/or the security module 422 are part of a management application on the management server 402 that are not part of a data import tool 152. A connection port 414 is depicted in the data import tool 152 for convenience but the connection port 414, in some embodiments, is part of the management server 402 and may be used for other functions.

The apparatus 400 includes a signature module 410 configured to generate a unique signature at an off-premises server, e.g. management server 402. The management server 402 includes or has access to a billing system configured to process metering data 114 for a remote server 102 at an on-premises site and to generate a bill based on the metering data 114. The off-premises server is not connected via a data network 120 to an on-premises site with the remote server 102. The unique signature, in some embodiments, is unique to a contract with the customer leasing or renting the remote servers 102. In other embodiments, the unique signature is unique to the customer.

In some embodiments, the signature module 410 uses a random number generator to generate the unique signature. The random number generator may include just numbers, may include numbers and letters, may include numbers, letters, and other characters, or any other combination suitable for security. In other embodiments, the unique signature is unique computer readable code stored on the portable storage device 308 prior to being transported to the on-site premises and being connected to the data export tool 154. In some embodiments, the unique signature is encrypted by the signature module 410 and is unencrypted and read by the signature input module 322 of the data export tool 154.

Typically, the unique signature is generated in such a way that a hacker trying to replicate the unique signature will have a difficult time doing so. Typically, the unique signature has enough numbers, letters, and/or other characters so that discovery of the unique signature by trying different combinations would be difficult.

In some embodiments, the off-premises server (e.g. 402) stores account information regarding the remote server(s) 102 and/or other leased/rented equipment and the unique signature is correlated to the account information. The signature module 410 correlates the newly generated unique signature with the customer information, with a contract with the customer, with one or more remote servers 102, with other computing devices being leased or rented, etc. In some embodiments, the signature module 410 maintains, at the management server 402, a list of unique signatures each correlated with a customer, a contract, remote servers 102, etc. for later retrieval. One of skill in the art will recognize other unique signature types and other functions of the signature module 410 related to generating a unique signature for a customer and maintaining a correlation between the unique signature and the customer, a contract, equipment, etc.

The apparatus 400 includes a decryption module 412 configured to decrypt, by the off-premises server (e.g. management server 402), the encrypted metering data 114 using the unique signature. The portable storage device 308 is disconnected from the on-premises metering user interface when connected to the off-premises server (e.g. 402). Typically, a user transports the portable storage device 308 from the on-premises controller manager 116 to the off-premises server (e.g. management server 402). The management server 402 and/or data import tool 152 includes a connection port 414 capable of connecting to the portable storage device 308. For example, if the portable storage device 308 includes a USB connector, the connection port 414 will have an appropriate USB port for connection to the portable storage device 308.

The decryption module 412 accesses the encrypted metering data 114 through the connection port 414 and uses the unique signature to decrypt the encrypted metering data 114. In some embodiments, a user accesses the data import tool 152 using the electronic display and/or IO devices 406 and enters information about the customer, the contract, etc. to retrieve the unique signature for the decryption module 412 to use for decryption. In some embodiments, a user inputs the unique signature. In other embodiments, the portable storage device 308 includes information about the customer, contract, remote server 102, etc. and the decryption module 412 reads the information and uses the information to retrieve the unique signature. The information, in some embodiments, is separate from the encrypted metering data 114. In other embodiments, the information is included with the encrypted metering data 114, for example, as a header for a file that includes the encrypted metering data 114. One of skill in the art will recognize other ways for the decryption module 412 to access and use the unique signature to decrypt the encrypted metering data 114.

The apparatus 400 includes an upload module 416 configured to upload the metering data 114 using the off-premises server (e.g. 402). After decryption by the decryption module 412, the encryption module 416 uploads the decrypted metering data 114. In some embodiments, the decryption module 412 and the upload module 416 work together to decrypt and upload the metering data 114. In some embodiments, the upload module 416 stores the decrypted metering data 114 in a data storage device 408, which may be located in the management server 402 or accessible to the management server 402. For example, the data storage device 408 may be a virtual device mapped to storage devices in a storage area network (“SAN”). In some embodiments, the data storage device 408 is a computer readable storage medium.

The apparatus 400 includes, in some embodiments, a billing module 418 configured to generate billing information based on the uploaded metering data 114, and make the billing information available to a customer using the remote server 102. In some embodiments, the billing module 418 makes the billing information available to a billing portal 420. In some embodiments, the billing portal 420 is the HwaaS portal 124 in the public cloud 126. In some embodiments, the billing module 418 is part of the HwaaS portal 124 and imports or receives the decrypted metering data 114 from the data storage device 408 accessible to the management server 402. In other embodiments, the billing module 418 generates the billing information at the management server 402 and transmits the billing information to a billing portal accessible to the customer where the customer accesses the billing information.

The billing module 418 has billing rates and/or has access to billing rates that are used by the billing module 418 to generate the billing information. Where the metering data 114 includes power consumption data of the remote server 102, in some examples, the billing module 418 determines a number of kilowatt-hours (“kWH”) used by the remote server 102 and uses a rate or a formula to convert the kilowatt-hours used by the remote server 102 to a billed amount for a billing period of the metering data 114. In other embodiments where the metering data 114 includes other information, such as CPU utilization, GPU utilization, utilization of other computing devices, etc. the billing module 418 uses other billing rates along with the CPU utilization, the GPU utilization, etc. to create a bill for the customer. In some embodiments, the billing information made available to the customer includes graphs, charts, tabulated data, etc. for the customer to view that is useful in understanding equipment usage, trends, etc. One of skill in the art will recognize other ways for the billing module 418 to generate billing information from the metering data 114 and to make the billing information available to the customer using the remote server(s) 102.

In some embodiments, the apparatus 400 includes a security module 422 configured to generate an alert in response to determining that a signature other than the unique signature was used to encrypt the metering data 114. Where the decryption module 412 uses the unique signature to attempt to decrypt the encrypted metering data 114 from the portable storage device 308 and is unsuccessful because the unique signature was not used to encrypt the metering data 114 on the portable storage device 308, the security module 422 generates an alert. In some embodiments, the security module 422 displays the security alert on an electronic display 406 displaying an interface to the data import tool 152 so a user involved with decrypting and uploading the metering data 114. In other embodiments, the security module 422 sends the alert to a system administrator or other user. One of skill in the art will recognize other ways for the security module 422 to determine that a signature used to encrypt the metering data 114 on the portable storage device 308 does not match the unique signature.

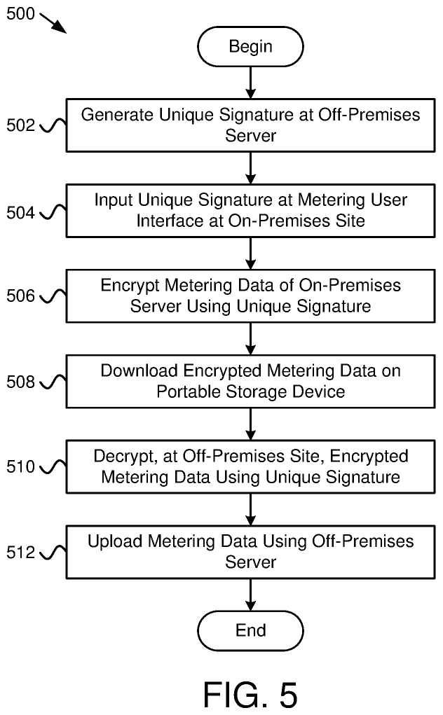

FIG. 5 is a schematic flow chart diagram illustrating a method 500 for collecting metering data 114 of on-premises computing resources without a network connection, according to various embodiments. The method 500 begins and generates 502 a unique signature at an off-premises server (e.g. 402) that has or has access to a billing system configured to process metering data 114 for a remote server 102 at an on-premises site and to generate a bill based on the metering data 114. The off-premises server (e.g. 402) is not connected via a data network 120 to an on-premises site with the remote server 102. The method 500 inputs 504 the unique signature at a metering user interface located at the on-premises site. The metering user interface includes access to metering data 114 of the remote server 102.

The method 500 encrypts 506 the metering data 114 of the remote server 102 using the unique signature and downloads 508 the encrypted metering data 114 to a portable storage device 308 accessible to the metering user interface at the on-premises site. The method 500 decrypts 510, by the off-premises server (e.g. 402), the encrypted metering data 114 using the unique signature. The portable storage device 308 is disconnected from the on-premises metering user interface when connected to the off-premises server 402. The method 500 uploads 512 the metering data using the off-premises server 402, and the method 500 ends. In various embodiments, all or a portion of the method 500 is implemented using the signature module 410, the signature input module 322, the encryption module 324, the download module 326, the decryption module 412, and/or the upload module 416.

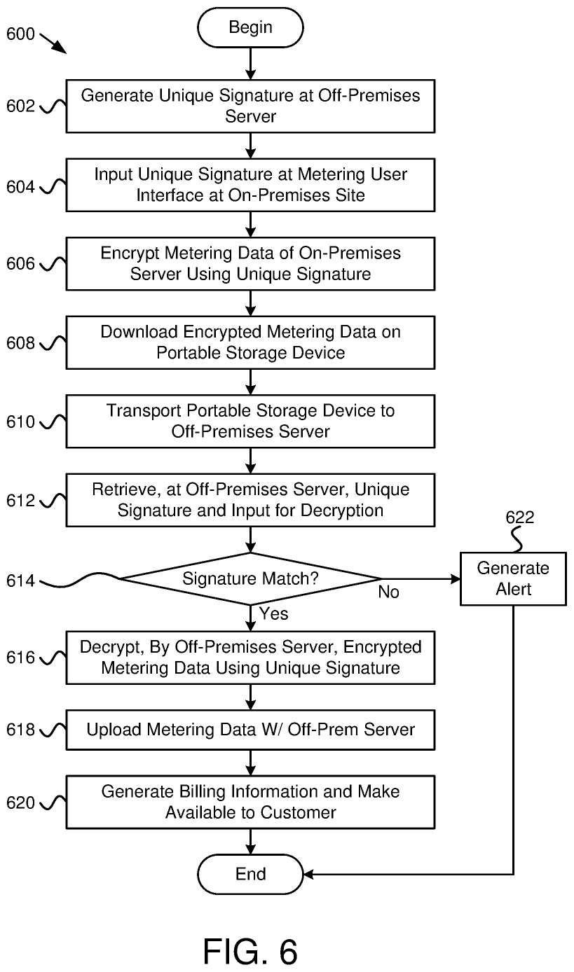

FIG. 6 is a schematic flow chart diagram illustrating another method 600 for collecting metering data 114 of on-premises computing resources without a network connection, according to various embodiments. The method 600 begins and generates 602 a unique signature at an off-premises server (e.g. 402) that has or has access to a billing system configured to process metering data 114 for a remote server 102 at an on-premises site and to generate a bill based on the metering data 114. The off-premises server 402 is not connected via a data network 120 to an on-premises site with the remote server 102. The method 600 inputs 604 the unique signature at a metering user interface located at the on-premises site. The metering user interface includes access to metering data 114 of the remote server 102.

The method 600 encrypts 606 the metering data 114 of the remote server 102 using the unique signature and downloads 608 the encrypted metering data 114 to a portable storage device 308 accessible to the metering user interface at the on-premises site. The method 600 transports 610 the portable storage device 308 to the off-premises server 402 and retrieves 612, at the off-premises server 402, the unique signature associated with the customer leasing/renting the remote server 102. The method 600 determines 614 if the retrieved unique signature for the customer matches a signature used to encrypt the metering data 114 on the portable storage device 308. If the method 600 determines 614 that the retrieved unique signature for the customer matches a signature used to encrypt the metering data 114 on the portable storage device 308, the method 600 decrypts 616, by the off-premises server (e.g. 402), the encrypted metering data 114 using the unique signature and uploads 618 the metering data 114 using the off-premises server 402.

The method 600 generates 620 billing information based on the uploaded metering data 114 and makes 620 the billing information available to a customer using the remote server 102, and the method 600 ends. If the determines 614 that the retrieved unique signature for the customer does not match the signature used to encrypt the metering data 114 on the portable storage device 308, the method 600 generates 622 an alert and the method 600 ends. The method 600 may display the alert and/or send the alert to a system administer or other user. In various embodiments, all or a portion of the method 600 is implemented using the signature module 410, the signature input module 322, the encryption module 324, the download module 326, the decryption module 412, the upload module 416, the billing module 418, and/or the security module 422.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
generating a unique signature at an off-premises server comprising a billing system configured to process metering data for a remote server at an on-premises site and to generate a bill based on the metering data, wherein the off-premises server is not connected via a data network to an on-premises site comprising the remote server;
inputting the unique signature at a server located at the on-premises site, the server comprising access to metering data of the remote server;
encrypting the metering data of the remote server using the unique signature;
downloading the encrypted metering data to a portable storage device at the on-premises site;
decrypting, by the off-premises server, the encrypted metering data using the unique signature, wherein the portable storage device is disconnected from the server at the on-premises site when connected to the off-premises server; and
uploading the metering data using the off-premises server.

2. The method of claim 1, further comprising:
generating billing information based on the uploaded metering data; and
making the billing information available to a customer, wherein the customer uses the remote server.

3. The method of claim 1, further comprising generating an alert in response to determining that a signature other than the unique signature was used to encrypt the metering data.

4. The method of claim 1, further comprising, in response to downloading the encrypted metering data, transporting the portable storage device with the encrypted metering data to a location accessible to the off-premises server.

5. The method of claim 1, wherein the unique signature is valid for a single instance of decrypting the encrypted metering data.

6. The method of claim 1, wherein the on-premises site comprises a data export tool configured to store metering data in a protected state, wherein the stored metering data at the on-premises site is inaccessible to users without credentials to access the stored metering data, and wherein the unique signature and/or a password provides to access the stored metering data.

7. The method of claim 1, wherein the off-premises server stores account information regarding the remote server and the unique signature is correlated to the account information, and further comprising, prior to decrypting the encrypted metering data, retrieving the unique signature by entering account information related to the encrypted metering data.

8. The method of claim 1, wherein the on-premises site comprises on-premises computer readable storage media reserved for storing metering data, wherein the on-premises computer readable storage media is sized to store metering data for more than one billing period.

9. The method of claim 1, wherein the metering data comprises power consumption data of the remote server, utilization of the remote server, and/or operational data of the remote server.

10. The method of claim 1, wherein the metering data of the remote server is gathered using metering capabilities connected to the remote server.

11. An apparatus comprising:
a processor; and
non-transitory computer readable storage media storing code, the code being executable by the processor to perform operations comprising:
generating a unique signature at an off-premises server comprising a billing system configured to process metering data for an remote server at an on-premises site and to generate a bill based on the metering data, wherein the off-premises server is not connected via a data network to an on-premises site comprising the remote server;
decrypting, by the off-premises server, encrypted metering data using the unique signature, the encrypted metering data on a portable storage device, wherein the encrypted metering data is metering data of the remote server, is encrypted using the unique signature and downloaded on to the portable storage device from a server at the on-premises site, and wherein the portable storage device is disconnected from the server at the on-premises site when connected to the off-premises server; and
uploading the metering data using the off-premises server.

12. The apparatus of claim 11, the operations further comprising:
generating billing information based on the uploaded metering data; and
making the billing information available to a customer using the remote server.

13. The apparatus of claim 11, the operations further comprising generating an alert in response to determining that a signature other than the unique signature was used to encrypt the metering data.

14. The apparatus of claim 11, wherein in response to downloading the encrypted metering data, a user transports the portable storage device with the encrypted metering data to a location accessible to the off-premises server.

15. The apparatus of claim 11, wherein the on-premises site comprises a data export tool configured to store metering data in a protected state, wherein the stored metering data at the on-premises site is inaccessible to users without credentials to access the stored metering data, and wherein the unique signature and/or a password provides to access the stored metering data.

16. The apparatus of claim 11, wherein the off-premises server stores account information regarding the remote server and the unique signature is correlated to the account information, and further comprising, prior to decrypting the encrypted metering data, retrieving the unique signature by entering account information related to the encrypted metering data.

17. The apparatus of claim 11, wherein the on-premises site comprises on-premises computer readable storage media reserved for storing metering data, wherein the on-premises computer readable storage media is sized to store metering data for more than one billing period.

18. The apparatus of claim 11, wherein the metering data comprises power consumption data of the remote server, utilization of the remote server, and/or operational data of the remote server.

19. The apparatus of claim 11, wherein the metering data of the remote server is gathered using metering capabilities connected to the remote server.

20. A program product comprising a non-volatile computer readable storage medium storing code, the code being configured to be executable by a processor to perform operations comprising:
generating a unique signature at an off-premises server comprising a billing system configured to process metering data for an remote server at an on-premises site and to generate a bill based on the metering data, wherein the off-premises server is not connected via a data network to an on-premises site comprising the remote server;
decrypting, by the off-premises server, encrypted metering data using the unique signature, the encrypted metering data on a portable storage device, wherein the encrypted metering data is metering data of the remote server, is encrypted using the unique signature and downloaded on to the portable storage device from a server at the on-premises site, and wherein the portable storage device is disconnected from the server at the on-premises site when connected to the off-premises server; and
uploading the metering data using the off-premises server.
